(19) United States
(12) Patent Application Publication
(10) Pub. No.: US 2013/0334218 A1
(43) Pub. Date: Dec. 19, 2013

(54) MICROWAVE HEATING WITH SUSCEPTOR

(71) Applicant: The Governors of the University of Alberta, Edmondton (CA)

(72) Inventors: Amirali Toossi, Edmonton (CA); Mojgan Daneshmand, Edmonton (CA); Daniel Elliot Sameoto, Edmonton (CA)

(73) Assignee: The Governors of the University of Alberta, Edmonton (CA)

(21) Appl. No.: 13/900,355

(22) Filed: May 22, 2013

Related U.S. Application Data
(60) Provisional application No. 61/650,466, filed on May 22, 2012.
(60) Provisional application No. 61/650,931, filed on May 23, 2012.

(51) Int. Cl. H05B 6/64

(52) U.S. Cl. CPC H05B 6/6491
USPC 219/759

(57) ABSTRACT

There is disclosed a method of heating a wafer for bonding, the method comprising adding a patterned susceptor close to a wafer interface, and applying microwave energy to the patterned susceptor. There is also disclosed an electrically conductive film, in direct contact with a relatively non-conductive substrate (preferably a thermoplastic) and made of individual electrically isolated elements (features) with a maximum dimension less than ¼ the wavelength used in the microwave, and minimum dimension greater than 100 um in the plane of the film. The film and substrate is selectively heated by resistive loss caused by dissipated energy from microwave radiation.

### CROSS-REFERENCE TO RELATED APPLICATIONS

This application claims the benefit under 35 USC 119(e) of U.S. provisional application Ser. No. 61/650,466 filed May 22, 2012 and U.S. provisional application Ser. No. 61/650,931 filed May 23, 2012, the content of both of which is hereby incorporated by reference.

### TECHNICAL FIELD

Wafer bonding, and heating of objects.

### BACKGROUND

Wafer bonding is widely used for packaging micro-fabricated devices such as microfluidic channels, MEMS sensors, and optical micro mirrors. This procedure involves heating the wafer up to the melting point of the bonding material.

However, the excessive heat can sometimes have irreversible effects on the devices. Therefore, selective heating of the wafer can be a good solution to solve this problem. In this respect, microwave-bonding technique has been proposed by Budraa et al. [1]. The concept behind this technique is based on the use of microwave radiation to induce current in a very thin conductive layer. The thickness of the conductive layer is smaller than the skin depth of the material (usually metal) and the induced current flow is the main source of relatively fast heat generation in the conductive layer.

Many microwave bonding techniques reported (i.e. [1] and [2]) utilize customized microwave cavities and microwave sources, which are relatively costly and less accessible for widespread use. Commercial microwave ovens have been recently recommended as an alternative [3]-[4] and combined either external metallic susceptors and solvents, or conducting polymers to heat up and weld polymer based microfluidics.

For a typical microwave oven power level, solid metal films are very vulnerable to sudden arcing and explosion and cannot be directly used for controllable heating. Therefore, customized metallic susceptors are required to produce localized controllable, efficient, and selective heating without arcing. Although, the microwave susceptor concept has been earlier used in microwave cooking industry ([5]-[6]), there is not much information available on them and to our knowledge, it has not been previously applied to wafer bonding. Efficient designs maximize the perimeter of the metallic patterns and also must be adjusted for the expected power levels in the microwave.

Poly(methyl methacrylate) (PMMA) is one of the most common thermoplastics used in fabrication of microfluidics due to its optical transparency, chemical compatibility, relatively low price and wide accessibility [9]. One of the biggest challenges in fabrication of microfluidics is achieving high yield bonding processes with minimum damage to the channels. For bonding thermoplastics, it is preferable to have the interface heated selectively and efficiently so as to minimize time and energy required.

Microwave bonding concept is based on having thin (smaller than the skin depth) electrically conductive intermediate layers at the bonding interface which accommodates the current induced by microwave radiations. The surface currents will then generate localized heat required for bonding. Other groups [10]-[13] have applied this technique to polymers but used either customized microwave cavities [10] or needed solvents or conductive polymers to achieve high strengths [12]-[13].

### SUMMARY

Here, in an embodiment, we propose to utilize metallic intermediate susceptor layer to provide fast, inexpensive and efficient bonding. To our knowledge this is the first study on efficient design of metallic microwave susceptors for bonding microfluidics in commercial microwave ovens. However, none of the previously published results of which we are aware provide rapid localized heating in inexpensive fashion.

In general, there is disclosed a method of bonding a first material, such as a wafer, to another material, the method comprising adding a patterned susceptor between the first material and second material, and applying microwave energy to the patterned susceptor. The patterned susceptor may be used to heat any object. The bonding may be carried out with the first material and second material pressed together.

In another embodiment, there is disclosed an electrically conductive film, in direct contact with a relatively non-conductive substrate, preferably a thermoplastic, and made of individual electrically isolated elements for example with a maximum dimension less than ¼ the wavelength used in the microwave, and minimum dimension greater than 100 um in the plane of the film. The film and substrate is selectively heated by resistive loss caused by dissipated energy from microwave radiation.

These and other aspects of the device and method are set out in the claims, which are incorporated here by reference.

### BRIEF DESCRIPTION OF THE FIGURES

Embodiments will now be described with reference to the figures, in which like reference characters denote like elements, by way of example, and in which:

FIG. 1 is a microwave heating system.

FIG. 2A shows a microwave susceptor for microfluidics. FIG. 2B shows a microwave susceptor for use with die bandings.

FIG. 3 shows an example of a back-to-back sine-wave microwave susceptor pattern.

FIG. 4 shows an example of a semi-circular sine-wave microwave susceptor pattern.

FIG. 5 shows an example of an array of dots microwave susceptor pattern.

FIG. 6 shows a further example of a microwave susceptor pattern.

FIG. 7 shows a further example of a microwave susceptor pattern.

FIG. 8 shows a further example of a microwave susceptor pattern.

FIG. 9 shows a bonding system.

FIG. 10 shows the bonding system of FIG. 9 with moderate pressure applied by a wave guide.

### DETAILED DESCRIPTION

Immaterial modifications may be made to the embodiments described here without departing from what is covered by the claims.

We have developed a novel low cost technique for applying localized heating. Generated localized heating can be used for applications such as localized bonding (i.e. in fabrication of microfluidics devices, MEMS packaging, radio frequency (RF) device packaging) and microwave welding of plastics.

The concept behind this technique is based on ‘Microwave Bonding’ concept first implemented by Budraa et al. (1999). Microwave bonding is based on the use of microwave radiation to induce current in a very thin conductive layer. The induced current flow is the main source of relatively fast heat generation in the conductive layer.

We use conventional microwave ovens as energy source and add a designed (pattern) metallic susceptor to the wafer interface to produce localized heating. For a typical microwave oven power level, solid metal films are very vulnerable to sudden arcing and explosion and cannot be directly used for controllable heating. Therefore, customized metallic susceptors are required to produce localized controllable, efficient, and selective heating without arcing. The specific design of the metallic patterns can produce heating at different rates at the same time in a microwave field either from specific efficiencies from the shapes of the susceptor designs, or by altering the density of different heating elements.

Thus in one embodiment, there is disclosed a method of heating a wafer for bonding, the method comprising adding a patterned susceptor close to a wafer interface, and applying microwave energy to the patterned susceptor. Close in this instance means sufficiently close to produce heat to enhance bonding.

In another embodiment, there is disclosed an electrically conductive film, in direct contact with a relatively non-conductive substrate (preferably a thermoplastic) and made of individual electrically isolated elements (features) with a maximum dimension less than ¼ the wavelength used in the microwave, and minimum dimension greater than 100 um in the plane of the film. The film and substrate is selectively heated by resistive loss caused by dissipated energy from microwave radiation.

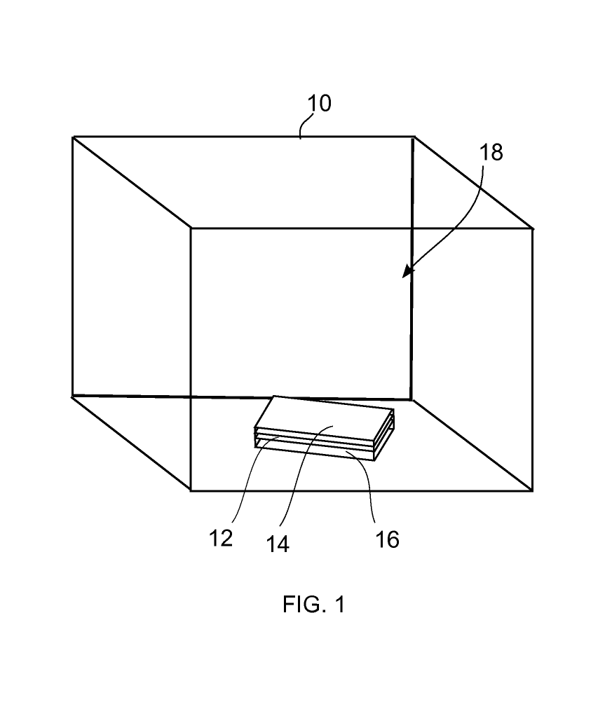

Referring to FIG. 1, the microwave heating system includes: Microwave oven 10 with a microwave cavity 18, microwave susceptor 12 and a first material for example a wafer 14 to be bonded to a second material such as a substrate material 16. Microwave oven 10 can be any conventional microwave oven including controls, a capacitor, a magnetron, a magnetron control circuit, a waveguide, a microwave chamber, a power cord, and a door. These are conventional elements that are represented schematically by the box shown and do not need further discussion. The microwave oven can have a range of microwave energy from 300 GHz-300 MHz, for example 2.45 GHz.

The first material and second material may each have any suitable shape for example rectangular, planar, cubic, cylinder or sphere, providing there is sufficient contact area across an interface between the first material and the second material to provide bonding between the first material and the second material. The patterned susceptor may have a matching shape and this may be easily achieved by having the patterned susceptor sufficiently flexible to follow the contours of the interface. In the case of FIG. 1, the susceptor 12 is planar and lies between the flat surfaces of the wafer 14 and substrate 16. If the first material has a curved surface, the second material would then have a matching curve, but inverted, so for example a concave first material and convex second material.

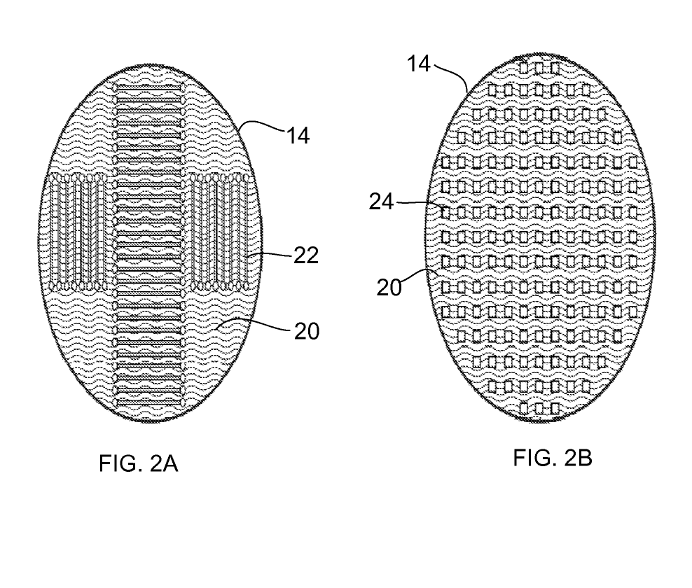

FIG. 2A shows a microwave susceptor for microfluidics, with a microwave susceptor, comprising individual electrically isolated elements 20, and microfluidic channels 22 in contact with a wafer 14. FIG. 2B shows a microwave susceptor for use with die bandings, with a microwave susceptor, comprising individual electrically isolated elements 20, and dies 24 in contact with a wafer 14.

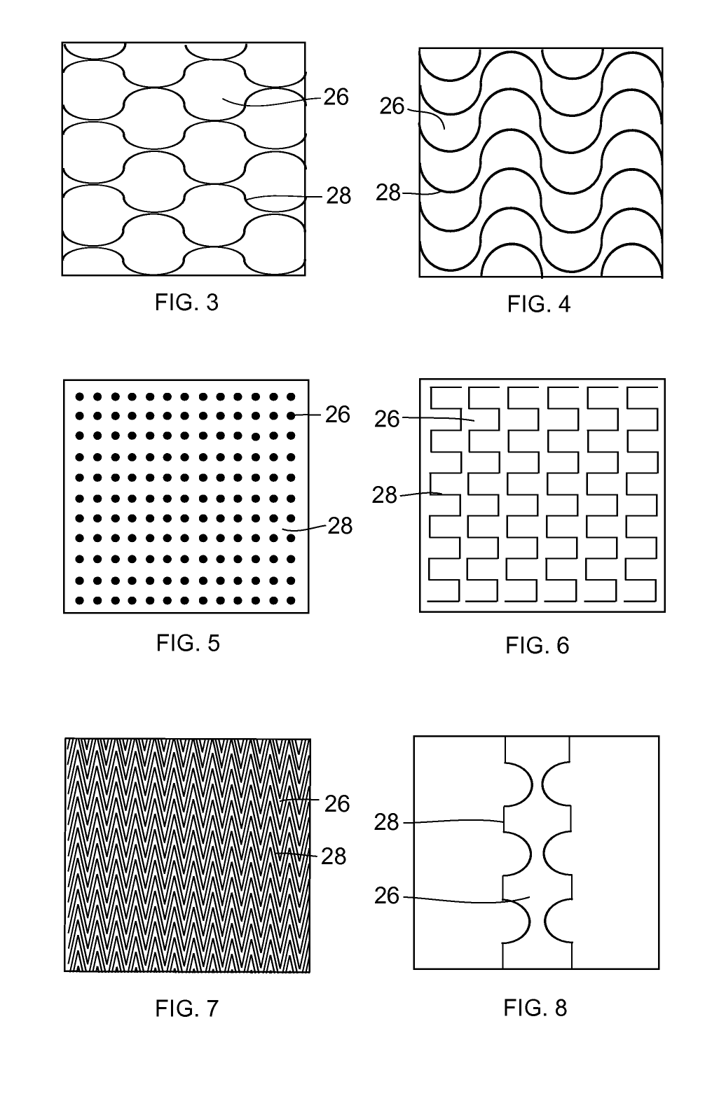

In some embodiments, the conductive susceptor could be metal, semiconductor, carbon, conductive polymer or other conductive materials that respond to microwave energy. The heating rate of the film is proportional to the joule heating caused by RF currents, with maximum currents occurring at the perimeter of each individual feature (as discovered by simulation and confirmed with experiments). The heating in the film elements is a function of the size and shape of the film elements, the intensity and the direction of the magnetic field tangent to the film and the resistivity of the film. The heating rate per area is controlled by the design of the susceptors to correct for the variability expected from standing waves in the microwave cavity (to get uniform heating rates) or designed to heat some areas faster than others, by either increasing the density of susceptor elements or efficiency of the designs on the assumption of a time averaged uniform intensity electromagnetic field. The susceptor elements can heat a thermoplastic or other material past its glass transition temperature and combined with a moderate pressure will bond said material to another compatible surface through van der Waals interactions, welding, diffusions of molecules or other mechanisms. A moderate pressure means a pressure that holds the materials together without impeding the bonding. In a preferred embodiment, the second surface has a substantially lower glass transition temperature (possibly lower than the bulk of either material) which allows localized welding without thermal damage to either of the two materials. Forcing the RF currents to go around sharp corners increases the current density, and the heating rate is proportional to the current squared. This is why we try to design arrays with high perimeter, relatively small individual areas and with a wavy perimeter. Examples of features 26 and breaks 28 are shown in FIGS. 3-8. Hollow features of the type shown in FIG. 3 are predicted to work since they should provide better areas in contact for polymers, while still being effective at heating.

For large wafer sizes to achieve uniform current distribution, various designs can be done to compensate for the field variation and field direction in the microwave oven meaning high efficiency designs for the hot spots and lower efficiency designs for the colder spots. Each individual design comprises a set of features. The features are continuous areas of electrically conductive material for example that may extend across the susceptor. There may be multiple side by side features. Various methods may be used to pattern the features such as by using masks or direct patterning of a planar conductive film with a laser. The features may individually be formed of repeated patterns, such as areas with varying width, or the features may have varying design depending on the expected distribution of microwave energy that they will be used with. Features lying side by side may be separated by breaks in the conductive film that are uniform in width, that may be linear or may have varying width. The breaks may extend across the film. The different features may be held together by being attached to a substrate that is transparent to microwave energy at the frequency being used. FIG. 3 is an example of repeating features 26 that widen and narrow and extend across the board. FIG. 4 is an example of repeating features 26 that widen and narrow as they extend across the board. FIG. 5 is an example of repeating features 26 in the form of isolated circles that extend across the board. FIG. 6 is an example of repeating features 26 that widen and narrow as they extend across the board. FIG. 7 is an example of repeating features 26 that widen and narrow as they extend across the board. FIG. 8 is an example of a feature 26 that widens and narrows as it extends across the board.

Any microwave susceptor material would work, so for example carbon toner can be printed onto a substrate. A conducting polymer would work too. The requirements are that it's a thin microwave susceptor that's patterned with certain dimensions based on the microwave wavelength and the pattern allows for a uniform heat distribution or some other distribution as desired, depending on the specific parameters of the equipment and the device to be fabricated. The design and perimeter of the metal/susceptor would be optimized. The applications, besides microfluidics, can include microinjection and embossing of plastic substrates or other applications involving heating of plastics that otherwise do not heat up in the microwave. In general, the susceptor elements may be used to heat an object such as such as glass, alumina, high resistivity Si or any other low RF loss substrate. At the microscale, the edges of the patterns are somewhat rough and this may contribute to the heating as well. The application cold also cover bonding RF devices that are smaller than wavelength of the microwave or operating at much higher frequency compared to the microwave oven frequency. The inventors have carried out a test of the principles of the invention as disclosed here, and soundly predict that the disclosed microwave energy ranges, shapes and materials will work based on the similarity of the radiation, shapes and materials to the tested radiation, shapes and materials. That is, a skilled person reading our disclosure would understand that the disclosed radiation, shapes and materials would work.

The microwave heating system used in this study consisted of a commercial microwave oven (Panasonic NNSA630 W), PMMA substrates (1×1×0.06″Plaskolite© OPTIX Acrylic), and thin metallic microwave susceptors (gold). Metal parts much smaller than the microwave wavelength do not heat efficiently inside the microwave oven. On the other hand, metallic patterns that are too large or contain acute angles are prone to micro-sized explosions. Therefore, susceptor design is vital in achieving controllable, efficient heating at the bonding interface. In our previous study [A. Toossi, M. Daneshmand, D. Sameoto, “Microwave Susceptor Design for Wafer Bonding Applications”, Accepted in IEEE MTT-S Int. Microwave Symp. Dig., July, (2012), the content of which is hereby incorporated by reference where permitted by law.], we have presented microwave susceptor design details based on electromagnetic simulations and this work is the first successful bonding of thermoplastics using these designed susceptors. Designed microwave susceptor patterns were produced by sputtering 15 nm of gold on acrylic substrates through a stencil cut from 0.035 inch thick acrylic sheets using a Versa Laser VLS 3.5 CO2 laser cutter. The heating curve based on the color change of the thermolabels of the fabricated susceptors shows a rapid initial increase in temperature that slows as the temperature reaches an upper limit.

To avoid excessive field concentration, an area of intermediate electric field intensity in the microwave cavity is chosen as our test location. For bonding tests, microfluidic channels and reservoirs were cut into acrylic substrates using a CO2 laser cutter.

Two PMMA substrates, one with microfluidic channels and the other coated with gold susceptors were held together by elastic bands to exert moderate pressure and were then placed at the test location inside the microwave oven cavity. After running the microwave at 100% power (1200 W) for 45 seconds the substrates were bonded and channels were sealed without leaks. Bonding is very consistent over the 1×1″ size of our substrates due to relative field uniformity. Heating uniformity is related to the uniformity of the MSCD and shows marked improvements in discrete metallic susceptors over a solid metal film of the same size.

PMMA bonding using microwave susceptors and commercial microwave ovens provides inexpensive, rapid and easy microfluidic device fabrication. This is the first demonstration of how specific metal susceptor designs can produce improved heating uniformity and polymer bonding. Future studies will focus on characterizing the bond strength for different power levels and heating times and the use of other lower-melting point materials as an intermediate layer for bonding in less time.

The microwave heating system includes: Microwave oven, microwave susceptor and substrate material. Panasonic NNSA630 W (inverter technology) microwave oven was chosen for our experiments because its power level may be controlled in a continuous manner rather than through duty cycle. A thin layer of aluminum (100 nm) was selected as our susceptor material to correspond to our prototypes. For our substrate material PMMA was chosen due to its transparency to microwave power (low RF power loss) [7] and wide application in polymer microfluidics.

Here, we use conventional microwave ovens and add a patterned metallic susceptor to the wafer interface to produce localized heating.

ANSYS HFSS© software was used to determine the field distribution in the cavity based on measurements of the interior of our microwave oven. A rectangular waveguide operating at 2.45 GHz and on its dominant TE10 mode is used to feed the cavity. The glass turntable has been removed from our model both in the simulation and experimental phases of the project.

Wave port excitation in all of our simulation results is normalized to 1 W. The electric field distribution simulation of the cavity has been verified with wet heat-sensitive fax paper tested in the microwave oven. In our simulation model instead of the actual thickness of the aluminum layer, a surrogate material 10 μm thick but with the same surface resistance as the aluminum was used to allow acceptable computation time with a coarser mesh size [8].

For this initial study, the sample is located in an area of intermediate intensity of the electric field (avoiding hot and cold spots). Based on our simulation results, we observe that the electric field variation is less than 15%. Additionally, our sample sizes are chosen to be much smaller than our wavelength (<˜0.2λ) to avoid resonances and obtain limited current with controllable heat generation.

The goal in the design of a susceptor for ultimate use in bonding applications is to be able to control the generated heat from the current flow on the metal patterns, at the same time, produce efficient and rapid heating. This results in localized and selective heating and helps in increasing the temperature on the package rim and not the device area. The simulations for the samples are carried based on the details explained in section II. In our experiments, a novel low cost and fast prototyping method was used. Instead of time-consuming and relatively expensive cleanroom processes, low-cost Acrylic Mirrors (FABBACK® Acrylic Mirror Clear) were used to prepare metallic susceptors. The mirrors consist of 1/16 of the field distribution and the location of our sample for the entire thick PMMA, approximately 100 nm thick aluminum on the study in respect to the field. PMMA and a protective paint layer on top of the aluminum. Designed aluminum patterns were transferred onto the aluminum sheet using Versa Laser VLS3.50 CO2 laser cutter (50 W laser power), which could raster or vector cut the paint, aluminum and a small thickness of the PMMA using a power level of 15% and speed setting of 25% of the laser maximum values.

Based on our results, we classify susceptor patterns into three categories: 1—non-controlled, 2—inefficient, and 3—efficient and controllable. Among these categories, the first and second ones represent undesirable results and the third category is our preferred proposed patterns.

1-Non-controlled heating: To demonstrate an example of this situation a 1 inch² non-patterned sheet of aluminum was simulated. The complete sheet showed a considerable amount of current density magnitude variation on its surface with the highest values (and therefore heating rates) located at the perimeter. Having large magnitude differences along the surface is very likely to cause explosions as it causes large heat generation rate difference, which is followed by large stress generation on the aluminum film. This has been also experimentally tested, as arcing across the film is observed almost immediately after the microwave cavity is excited at 50% power (600 W).

2-Inefficient Pattern: Patterns with susceptor dimensions below a certain threshold appear to not generate significant current densities and can take several minutes to heat up to the point where we can measure the temperature.

3-Efficient and controllable: Many initial designs were conceived and tested, but only a few are demonstrated here for brevity. These designs have a high perimeter and several areas of narrowing metal to enhance the areas of high current density. Very large individual metal areas are avoided to reduce the chance of arcing which mostly occurs across an individual metal susceptor, rather than between susceptors.

Also to be avoided are sharp, acute angles within the susceptor elements as micro-sized arcing appears common on those locations due to the very high current density generated. The sample temperatures were taken using multiple Nichiyu Giken Kogyo co. thermo-labels attached to the samples during microwave heating trials. The labels change color once a specific temperature is reached and testing on pure PMMA under the same conditions indicated no significant thermal heating of the labels themselves under microwave operation. Temperature vs. time graphs for samples with a semi-circular wave pattern, a back-to-back sine-wave pattern and an array of dots pattern consist of two curves, one showing temperature vs. time for the first recorded temperature change on each thermo-label when the microwave is running at 600 W and the a lower curve for when the complete 5 mm diameter circle (thermo-label surface size) has changed color. Cloudy areas on the samples after microwave heating trials indicated that the PMMA was heated beyond 150° C. and the aluminum wrinkled, giving a secondary visual indication of the uniformity of heating. A new approach for generating localized heating using optimal microwave susceptor in conventional microwave oven is proposed for bonding applications. It is shown that induced current densities and locations can be significantly affected by the exact susceptor designs and as a result heat generation rate in specific areas can be controlled. We have demonstrated that microwave susceptors can be prototyped using inexpensive materials and methods and general heating estimates may be found by getting current density information using ANSYS HFSS©. An efficient susceptor design for bonding applications would heat as uniformly and as quickly as possible for a given microwave power to ensure that local heat sink effects from the substrates would be minimized and heating/melting would be localized only to the susceptor areas. Finding the most efficient susceptor designs that are not vulnerable to arcing yet will heat as uniformly as possible are our immediate goals and these new designs will be applied to bonding polymer based microfluidics as an initial application.

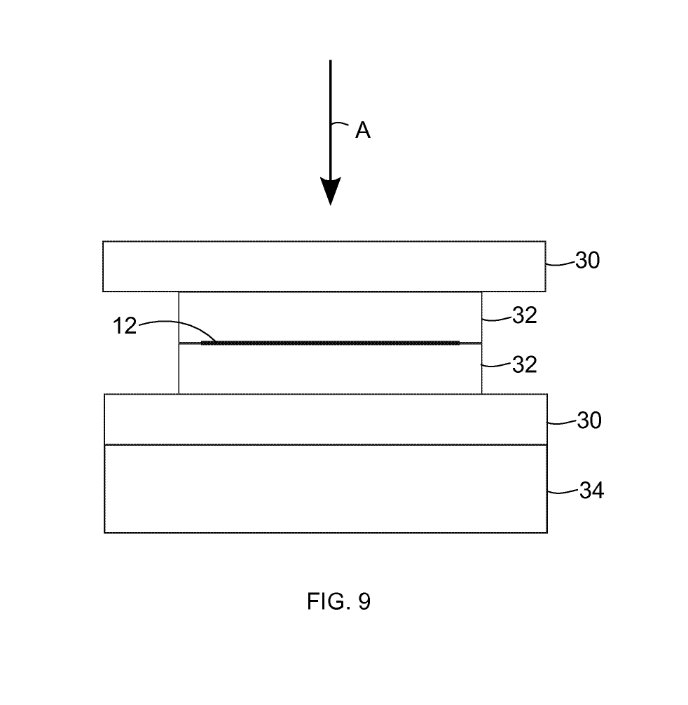

Referring to FIG. 9, materials 32 may be bonded under a moderate pressure sufficient to produce molecular contact between the surfaces to be bonded as heating proceeds, for example between 20 kPa and 1 MPa. No molecular contact means no bonding or very weak bonds. The pressure used depends on the materials to be bonded and overall flatness of the surfaces. A bonding system may include materials to be bonded 32 between microwave transparent materials 30, on a microwave reflective or transparent base 34, with a microwave susceptor 12 between the materials to be bonded 32. Arrow A represents an applied force. The force may be applied by any suitable means. The system can be in a microwave oven. The parts that apply pressure may be strong, rigid, microwave transparent, and high temperature tolerant to withstand the expected heating rates and maximum temperatures in the bonding process. The microwave transparent material may be rigid and high temperature tolerant, for example quartz. The pressure should be as evenly distributed as possible to achieve the best possible contact with minimal voids between bonded surfaces. The microwave bonding process may take place in a microwave oven.

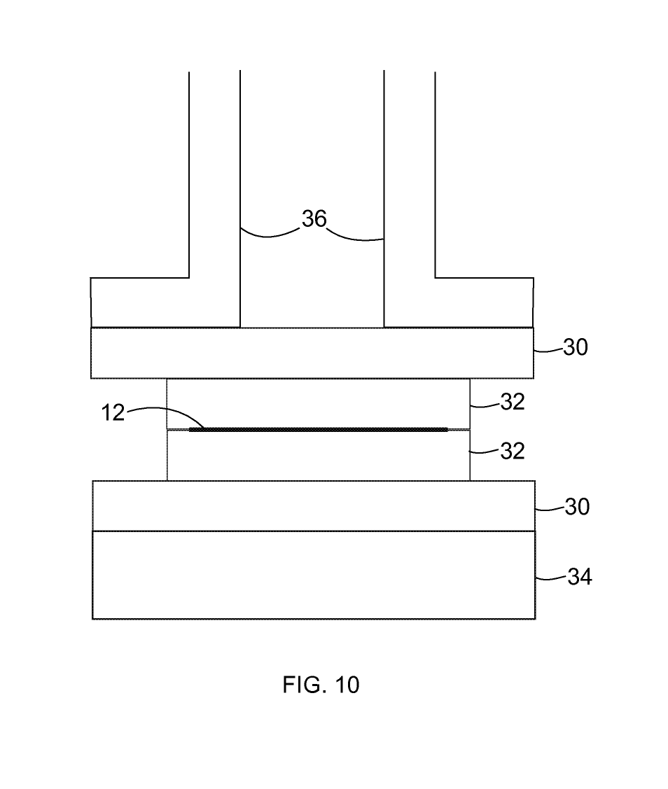

Referring to FIG. 10, a wave guide 36 could be used to apply the moderate force to the bonding system shown in FIG. 9. The microwave transparent material may also extend into the waveguide to improve the mechanical strength of the top microwave transparent material for applying pressure to the bonded materials. The whole bonding system can be contained within a bigger cavity to contain microwaves and may be evacuated of all air (for extremely demanding bonding requirements for example). The bonded materials may be smaller or larger than the waveguide. The susceptor area is preferably matched to the expected standing waves associated with the design, for example as generated by the microwave waveguide.

In the claims, the word “comprising” is used in its inclusive sense and does not exclude other elements being present. The indefinite articles “a” and “an” before a claim feature do not exclude more than one of the feature being present. Each one of the individual features described here may be used in one or more embodiments and is not, by virtue only of being described here, to be construed as essential to all embodiments as defined by the claims.

### REFERENCES

[1] N. K. Budraa, H. W. Jackson, M. Barmatz, W. T. Pike, and J. D. Mai, “Low pressure and low temperature hermetic wafer bonding using microwave heating,” in Proc. 12th IEEE International Conference on Micro Electro Mechanical Systems, Orlando, Fla., 1999, pp. 490-492.
[2] K. Thompson, Y. B. Gianchandani, J. Booske, and R. Cooper, “Si—Si Bonding Using RF and Microwave Radiation,” in Tech. Dig., IEEE International Conference on Solid-State Sensors and Actuators (Transducers' 01), 2001.
[3] M. Rahbar, S. Chhina, D. Sameoto, and M. Parameswaran, “Microwave-induced, thermally assisted solvent bonding for low-cost PMMA microfluidic devices,” Journal of Micromechanics and Microengineering, vol. 20, no. 1, p. 015026, January 2010.
[4] R. J. Holmes, C. McDonagh, J. A. D. McLaughlin, S. Mohr, N. J. Goddard, and P. R. Fielden, “Microwave bonding of poly(methylmethacrylate) microfluidic devices using a conductive polymer,” Journal of Physics and Chemistry of Solids, vol. 72, no. 6, pp. 626-629, June 2011.
[5] W. C. Winters, H.-hsin Chang, G. R. Anderson, R. A. Easter, and J. J. Sholl, “Microwave heating package, method and susceptor composition,” U.S. Pat. No. 4,283,427, 8 Nov. 1981.
[6] A. N. Dodge, N. F. David, and J. Q. Mendoza, “Susceptor for microwaveable food,” U.S. Pat. No. D545 125 S, 26 Jun. 2007.
[7] Kin Fong Lei, W. J. Li, N. Budraa, and J. D. Mai, “Microwave bonding of polymer-based substrates for micro-nano fluidic applications,” in Proc. 12th International Conference on Solid-State Sensors and Actuators (Transducers '03), Boston, Mass., 2003, pp. 1335-1338.
[8] M. Soltysiak, W. Gwarek, M. Celuch, and U. Erle, “FDTD modelling of plain susceptors for microwave oven applications,” in 2010 18th International Conference on Microwave Radar and Wireless Communications (MIKON), 2010, pp. 1-4.
[9] C. Tsao and D. L. DeVoe, “Bonding of thermoplastic polymer microfluidics”, Microfluidics and Nanofluidics, vol. 6, no. 1, pp. 1-16, November, (2008).
[10] Kin Fong Lei, W. J. Li, N. Budraa, and J. D. Mai, “Microwave bonding of polymer-based substrates for micro-nano fluidic applications”, in TRANSDUCERS, Solid-State Sensors, Actuators and Microsystems, 12th International Conference on, vol. 2, pp. 1335-1338, (2003).
[11] N. K. Budraa, H. W. Jackson, M. Barmatz, W. T. Pike, and J. D. Mai, “Low pressure and low temperature hermetic wafer bonding using microwave heating”, in Twelfth IEEE International Conference on Micro Electro Mechanical Systems (MEMS '99), pp. 490-492, (1999).
[12] M. Rahbar, S. Chhina, D. Sameoto, and M. Parameswaran, “Microwave-induced, thermally assisted solvent bonding for low-cost PMMA microfluidic devices”, Journal of Micromechanics and Microengineering, vol. 20, no. 1, p. 015026, January, (2010).
[13] R. J. Holmes, C. McDonagh, J. A. D. McLaughlin, S. Mohr, N. J. Goddard, and P. R. Fielden, “Microwave bonding of poly(methylmethacrylate) microfluidic devices using a conductive polymer”, Journal of Physics and Chemistry of Solids, vol. 72, no. 6, pp. 626-629, June (2011).

1. A method of bonding a first material and a second material, the method comprising placing a patterned susceptor between the first material and the second material, and applying microwave energy to the patterned susceptor.

2. The method of claim 1 further comprising applying pressure to the first material and the second material to press the first material and second material together during the application of microwave energy.

3. The method of claim 1 in which the first material is a wafer and further comprising heating the wafer with the microwave energy past its glass transition temperature under pressure to bond the wafer to the second material.

4. The method of claim 3 in which the wafer is a thermoplastic.

5. The method of claim 3 in which the second material has a substantially lower glass transition temperature than the wafer.

6. A structure comprising an electrically conductive film in direct contact with a relatively non-conductive substrate for use in heating by microwave energy, the electrically conductive film having individual electrically isolated elements.

7. The structure of claim 6 in which each of the individual electrically isolated elements has a maximum dimension less than ¼ the wavelength of the microwave energy and minimum dimension greater than 100 um in the plane of the film.

8. The structure of claim 7 in which the relatively non-conductive substrate is a thermoplastic.

9. The structure of claim 7 in which the electrically conductive film comprises metal, a semiconductor, carbon, or a conductive polymer.

10. The structure of claim 7 in which the electrically conductive film is printed onto a substrate.

11. The structure of claim 7 in which the electrically conductive film is a susceptor.

12. The structure of claim 7 in which the individual electrically isolated elements are patterned with certain dimensions based on the wavelength of microwave radiation.

13. The structure of claim 12 in which the individual electrically isolated elements are patterned to compensate for the expected variability of the microwave radiation to get uniform heating rates.

14. The structure of claim 12 in which the individual electrically isolated elements are patterned to achieve uniform radio frequency current distribution.

15. The structure of claim 6 in which the individual electrically isolated elements are designed to heat some areas of the electrically conductive film faster than other areas by increasing the density of the individual electrically isolated elements.

16. The structure of claim 6 in which the individual electrically isolated elements are designed to heat some areas of the electrically conductive film faster than other areas by increasing the efficiency of the designs on the assumption of a time averaged uniform intensity electromagnetic field.

17. The structure of claim 12 in which the individual electrically isolated elements have a wavy perimeter.

18. The structure of claim 12 in which the individual electrically isolated elements comprise repeated patterns.

19. The structure of claim 12 in which the individual electrically isolated elements comprise repeated patterns of varying width.

20. The structure of claim 7 in which the individual electrically isolated elements have varying designs depending on the expected distribution of microwave radiation.

21. The structure of claim 7 in which the individual electrically isolated elements are held together by a substrate that is transparent to microwave energy at the frequency being used.

22. The structure of claim 7 in which the individual electrically isolated elements comprise continuous areas of electrically conductive material.

23. The structure of claim 7 further comprising multiple side by side individual electrically isolated elements.

24. The structure of claim 14 in which the multiple side by side individual electrically isolated elements separated by breaks in the conductive film.

25. The structure of claim 15 in which the breaks in the conductive film are uniform in width.

26. The structure of claim 15 in which the breaks in the conductive film have varying width.

27. The structure of claim 15 in which the breaks in the conductive film are linear.

28. The structure of claim 15 in which the breaks in the conductive film extend across the electrically conductive film.

29. A method comprising exposing the structure of claim 6 to microwave radiation, wherein the electrically conductive film and non-conductive substrate are selectively heated by resistive loss caused by dissipated energy from the microwave radiation.

30. The method of claim 29 in which the electrically conductive film and non-conducting substrate are pressed together while being exposed to microwave radiation.
